(19) United States
(12) Patent Application Publication
(10) Pub. No.: US 2006/0218332 A1
(43) Pub. Date: Sep. 28, 2006

(54) Interface circuit, system, and method for interfacing between buses of different widths

(75) Inventor: David Boudreau, Arlington, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/090,624

(22) Filed: Mar. 25, 2005

(51) Int. Cl. G06F 13/40

(52) U.S. Cl. 710/307

(57) ABSTRACT

Interface circuits and methods for transferring data between buses of different widths are disclosed herein. The interface circuits comprise first control logic configured to provide a selection signal to a plurality of first distribution devices. Each of the first distribution devices controls communication between a respective byte register and a respective byte location on a first bus. The interface circuit further comprises second control logic configured to provide a selection signal to a second distribution device. The second distribution device controls communication between the plurality of byte registers and a second bus, where the second bus has a width of fewer bytes than the first bus.

### TECHNICAL FIELD

The present disclosure is related to transferring data between two buses having different widths. More particularly, the present disclosure is related to interface circuits, such as first-in, first-out (FIFO) circuits, for temporarily storing and transferring data between two buses in a time efficient manner.

### BACKGROUND

Processing systems commonly transfer data among a number of electrical components. As is well known, data transfer operations typically involve various memory components in communication with each other via data buses. Oftentimes, however, data is transferred across an interface where a first bus is connected to a second bus having a different width than the first bus. In this disclosure, the “width” of a bus refers to the number of bits of data that can be transferred along the bus at one time. Normally, since a wider bus allows more data to be transferred at one time, the wider bus can operate faster than a narrower bus.

To accommodate the transfer of data across an interface between buses of different widths, a first-in, first-out (FIFO) memory device is typically used in the interface circuitry. The FIFO memory device temporarily stores data from the wide bus and then feeds the narrow bus at the speed of the slower, narrow bus. FIFO memory devices can typically be designed in two different ways. First, the FIFO can be designed to be as wide as the wide bus so that the FIFO can receive all the data on the wide bus in one clock cycle. However, one problem with this design is that when only a portion of the wide bus contains valid data, the FIFO circuit is incapable of knowing which bytes of the data are valid. Thus, such a circuit would typically require an extra “valid” bit that goes along with the data to indicate whether each byte is valid or invalid. Also, the FIFO circuit will further require additional circuitry to monitor the valid bit to determine whether each byte is valid or not.

As is more popular in processing systems, a second design for a FIFO memory device provides another potential solution for the interface between data buses of different widths. In this design, data is transferred one byte at a time from the wide bus and read out to the slow bus one byte at a time. The main disadvantage of such a system is that a device operating on the wide bus will encounter a bottleneck condition. The device, such as a processor, a direct memory access (DMA) controller, or other type of data transferring device, connected to the wider bus, will remain busy feeding the slow bus at the slow speed and will hence be kept busy for the entire duration of the data transfer.

FIG. 1 is a schematic diagram of a FIFO circuit 10 used as part of a conventional interface circuit 12 between data buses having different widths. Particularly, the interface circuit 12 transfers data between a processor data bus 14 and a peripheral bus 16. A processor 18 can access data at high speeds along the wide processor data bus 14. The processor 18 includes internal circuitry 20, which is also a part of the interface circuit 12. During a writing procedure, this internal circuitry 20 communicates with a device (not shown) on the peripheral bus 16 by feeding data into the FIFO circuit 10 along an intermediate bus 22, which has the same width as the narrow peripheral bus 16. Since this internal circuitry 20 of the processor 18 can only feed data to the FIFO circuit 10 at the slow rate of the narrow bus 16 because of the limitations of the FIFO circuit 10 and narrow peripheral bus 16, the processor 18 remains busy with the data transfer and cannot go on to other processing tasks. In this respect, the speed of the processor 18 will not reach its maximum potential during these data transfers since it is limited by the slower bus 16.

The FIFO circuit 10 shown in FIG. 1 includes a memory array 24, a write counter 26, and a read counter 28. The memory array 24 is one byte wide for storing one byte at a time and may be any number of addresses deep. The memory array 24 is configured as a FIFO device to store a number of bytes of data equal to the number of addresses in the array. Data is then read out in the same order.

To request a write procedure, the processor 18 sends a “data_write” signal to the write counter 26 indicating a request to write. In response to the data_write signal, the write counter 26 increments an internal value that acts as a pointer to one of the addresses within the memory array 24. The write counter 26 accesses the address by the pointer count positioned at the next available memory address in the memory array 24 to indicate where the next byte will be stored.

A peripheral device connected on the peripheral bus 16 indicates when it is ready to receive the data stored in the memory array 24. The peripheral device sends a “data_read” signal, which is received by the read counter 28. In response to this signal, the read counter 28 increments another pointer value by one to the next memory address in the memory array 24 for reading the contents of that memory address. The memory array 24 then transfers data bytes one at a time to the peripheral bus 16.

FIG. 2 is a timing diagram of an example of transferring eight bytes using the conventional interface circuit 12 shown in FIG. 1. At a first clock cycle, for example, the processor 18 writes a first byte “byte_{—}0” via its internal circuitry 20 into the memory array 24. One clock cycle later, the processor 18 writes a second byte “byte_{—}1” into the memory array 24, and so on, one byte per clock cycle, until all bytes have been written. The memory array 24 can store up the data as it is written, one byte at a time. At some time after the start of the process for writing data from the processor 18 into the memory array 24, the read counter 28 may be instructed to begin accessing the data from the memory array 24 for writing onto the peripheral bus 16. From this timing diagram of FIG. 2, it can be seen that the processor 18 remains busy for the entire data transfer of all eight bytes to the memory array 24.

Because of the deficiencies of the prior art as mentioned above, it would therefore be desirable in the art to utilize an improved interface in the processing system. For example, it would be beneficial for an interface to provide means such that the processor is not tied up or forced to wait during the entire data transfer between a fast, wide bus and a slow, narrow bus. Furthermore, rather than force the processor to operate at the slow bus speed, it would also be beneficial for the interface circuit to allow the processor to access data at the speed of the wider, faster bus.

### SUMMARY

Disclosed herein are interface circuits and methods for transferring data between buses of different widths, wherein the methods result in faster processor speeds. One such interface circuit comprises first control logic and second control logic. The first control logic is configured to provide a selection signal to a plurality of distribution devices. Each distribution device controls communication between a byte register and a respective byte location on a wide bus. The second control logic is configured to provide a selection signal to another distribution device that controls communication between the plurality of byte registers and a narrow bus having a width of fewer bytes than the wide bus.

More particularly, the first control logic may receive a first signal and a second signal from a device on the wide bus, where the first signal indicates a request to access data in the byte registers and the second signal indicates the number of bytes of data to be accessed. Also, the first control logic may comprise a counter that increments by a number equal to the number indicated by the second signal. The interface circuit may be further configured such that the second control logic receives a signal from a device on the second bus indicating a request to access data in the byte registers. As an example, the second control logic may be a counter.

The interface circuit may further comprise a status checking module that is configured to receive a first count value from the first control logic and a second count value from the second control logic. In response to the first and second count values, the status checking module provides a stop signal or a continue signal to each of the first control logic and second control logic.

The present disclosure also describes a system for interfacing buses of different widths. One system for interfacing comprises, first of all, a plurality of temporary storage components. The system also includes components or modules, such as software modules, for transferring data between a first bus and at least one of the temporary storage components in a single clock cycle. The system also includes components or modules for transferring data between a second bus and the at least one of the temporary storage components in a number of clock cycles.

Methods are also disclosed for transferring a plurality of bytes of data between a first bus and a corresponding number of registers in one clock cycle and then transferring the plurality of bytes of data between a second bus and the registers one byte per clock cycle. The transferring steps are not necessarily carried out in that particular order but may be reversed, depending on whether a wider bus of the two buses is reading or writing.

### BRIEF DESCRIPTION OF THE DRAWINGS

Many aspects of the embodiments of the present disclosure can be better understood with reference to the following drawings. Like reference numerals designate corresponding parts throughout the several views.

FIG. 1 is a schematic block diagram of a conventional interface circuit between buses of different widths.

FIG. 2 is a timing diagram illustrating the involvement of the processor shown in FIG. 1.

FIG. 3 is a schematic block diagram of a first embodiment of an interface circuit between buses of different widths.

FIG. 4 is a schematic diagram of a second embodiment of an interface circuit.

FIG. 5 is a schematic diagram of a third embodiment of an interface circuit.

FIG. 6 is a schematic diagram of a fourth embodiment of an interface circuit.

FIG. 7 is a timing diagram of the activity of a processor operating in conjunction with one of the interface circuits of FIGS. 3-6.

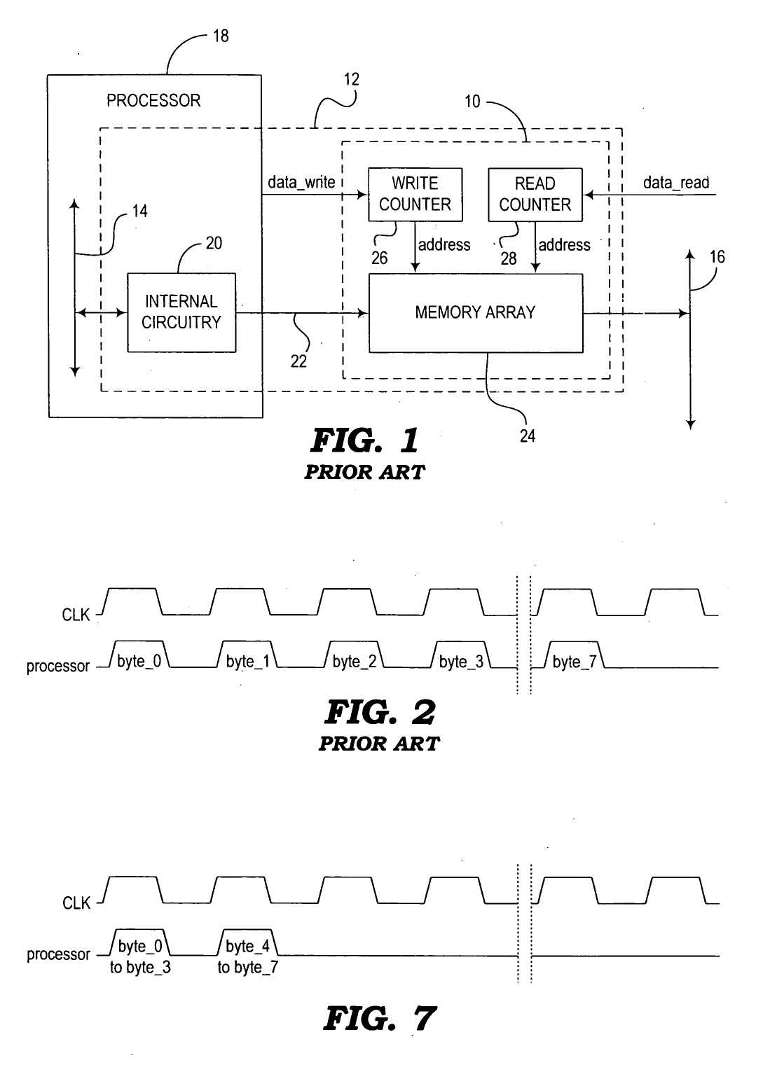

### DETAILED DESCRIPTION

Circuits for interfacing between buses of different widths and methods for carrying out data transfer operations between the buses are disclosed herein for overcoming the deficiencies of the prior art. Particularly, improved interface circuits allow devices operating on a wider bus to transfer data at the speed of the wider bus, not the speed of the narrower, slower bus. In the examples described herein, a “wide bus” will refer to a bus having a width of 32 bits, or four bytes, and a “narrow bus” will refer to a bus having a width of 8 bits, or one byte, unless otherwise noted. However, it should be recognized that these specific widths are used as a reference for the sake of illustration only and are not in any way intended to limit the disclosure in this respect. Instead, the buses may have any suitable widths, and preferably widths that are multiples of one byte. Furthermore, the wide bus and narrow bus may be any type of signal transmission channel or wireless communication channel for transmitting signals, data, instructions, etc. As an example, the wide bus may be configured as a processor data bus and the narrow bus may be configured as a peripheral bus for communication with one or more peripheral devices.

The embodiments of the present disclosure are also capable of operating as first-in, first-out (FIFO) devices in that the stored data is read in and read out in the same order. However, instead of using a memory array having storage dimensions of one byte wide and a number of addresses deep, the present application includes a number of individual registers, each of which can store and read out one byte. The embodiments described below not only maintain the proper order of transferred bytes of data, but they also simplify the transfer process by temporarily storing in the registers only the bytes that are valid.

The present disclosure includes embodiments of interface circuits that allow a processor, direct memory access (DMA) controller, or other suitable data transferring device, located on the wide bus, to access (read or write) from one to four bytes of data in one clock cycle. In this way, the processor or data transferring device will not be required to wait for a memory array to store or read out one byte at a time. Instead, the processor in these examples will be able to access the data quickly and then go on to perform other functions. The interface circuits, according to the teachings of the present disclosure, are capable of transferring data with the fast bus at the fast bus speed and transferring data with the slower bus at the slower rate. In this respect, the processor operating on the faster bus will be able to operate with fewer delays as compared with the prior art processors since the speed of the faster bus, not the slower bus, dictates the processor speed during the data transfer.

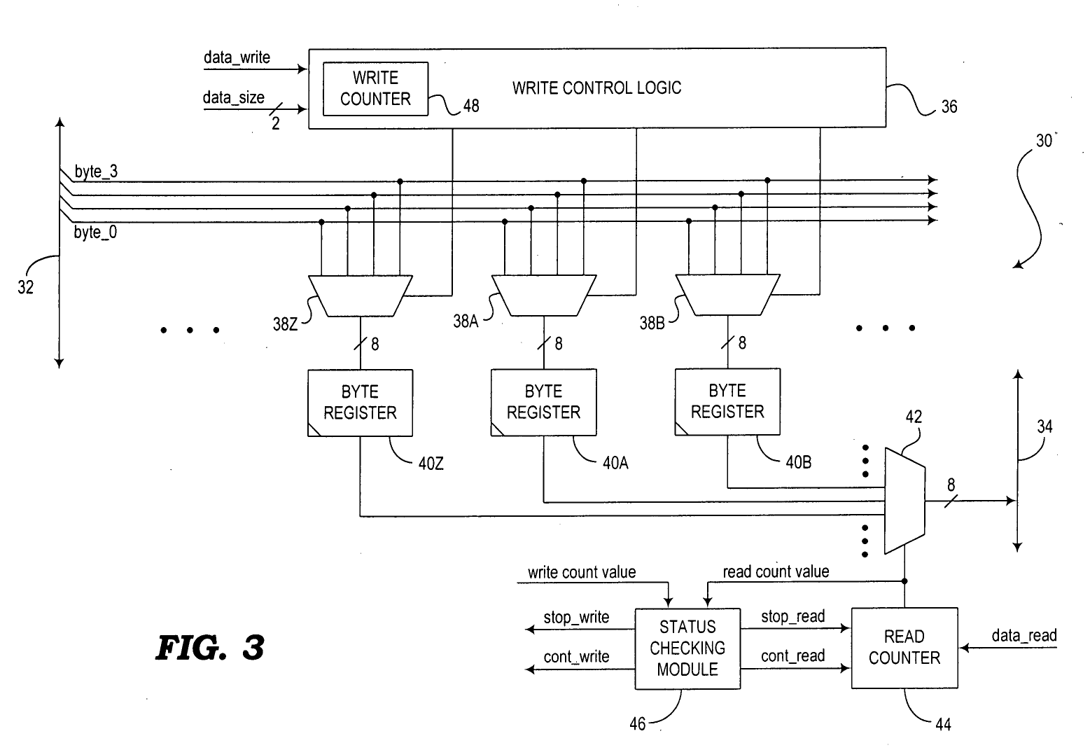

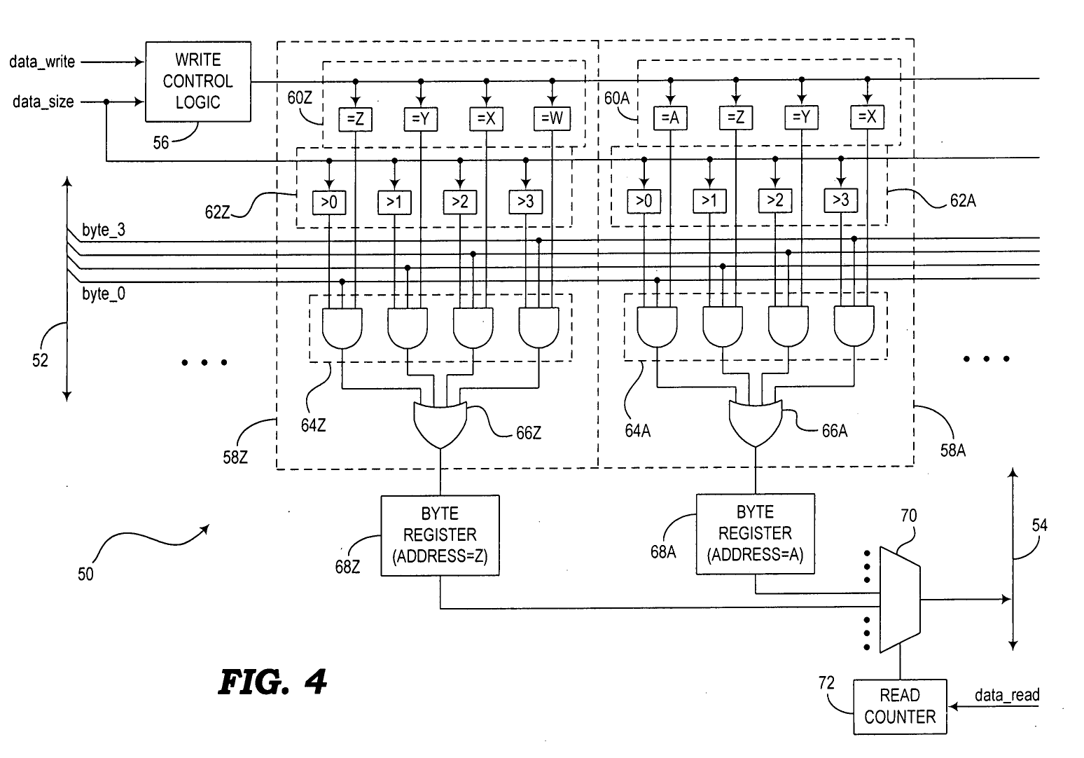

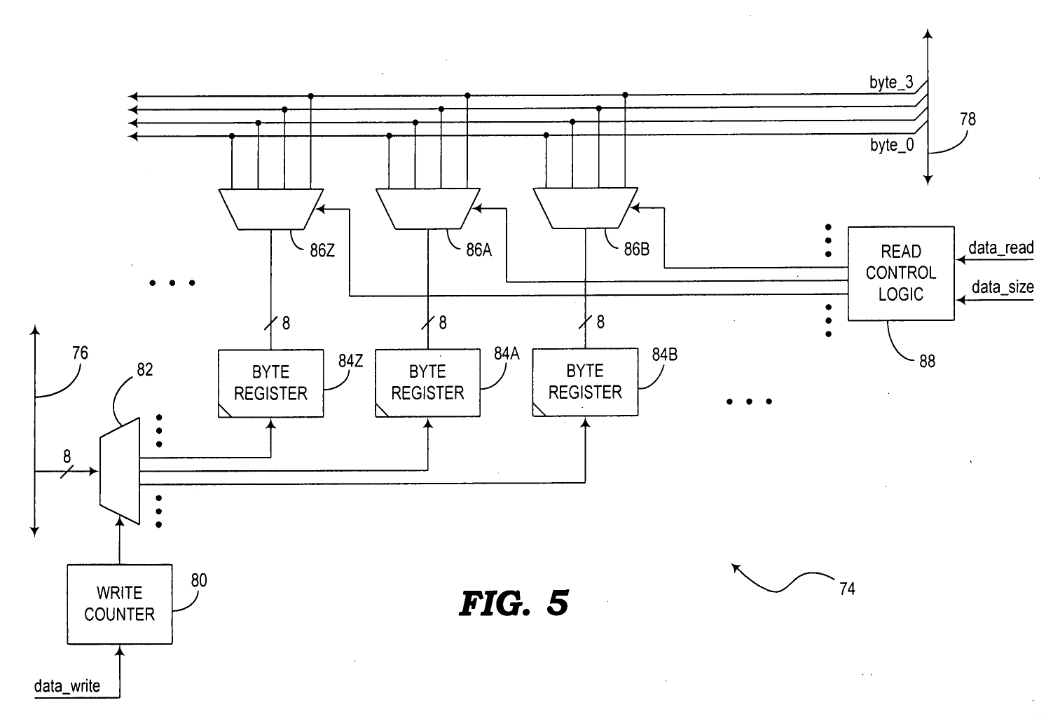

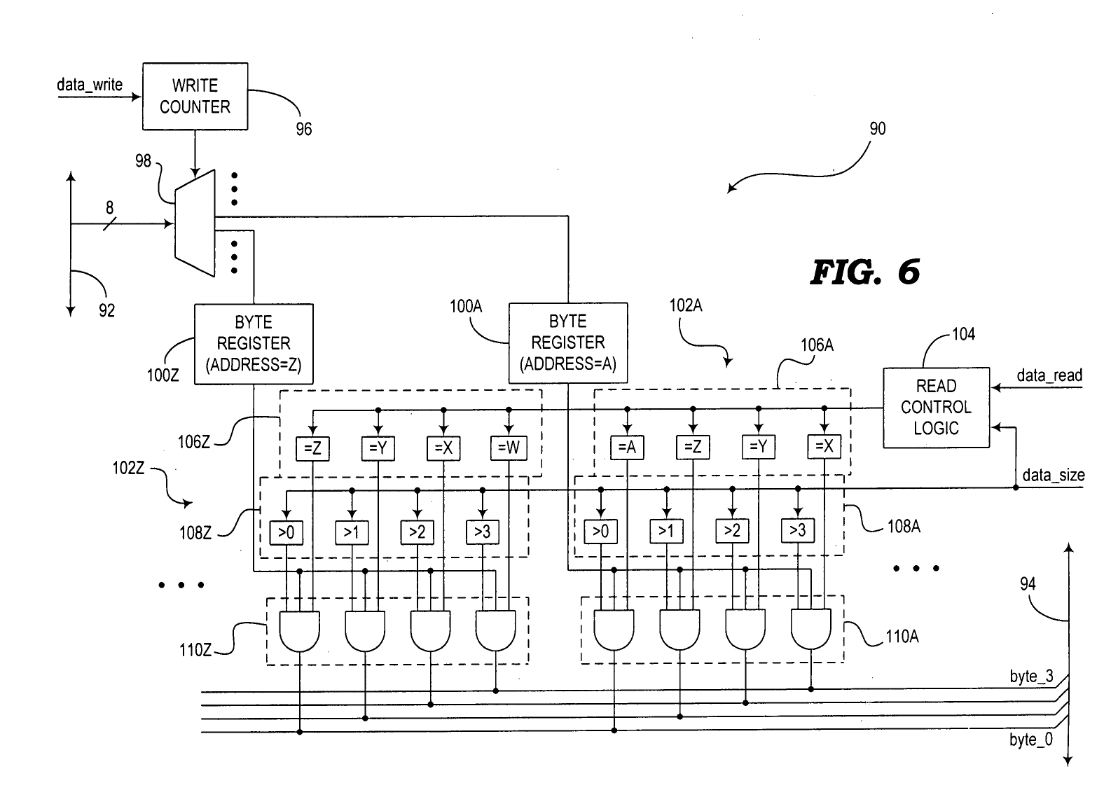

The present disclosure describes circuits that allow a device, such as a processor, on a fast bus to write to a device on a slower bus using a “burst writing” technique. Also described are circuits that allow a device, such as a processor, on a fast bus to read from a device on the slower bus using a “burst reading” technique. Methods describing such techniques are also described herein. FIGS. 3 and 4, described below, are directed to interface circuits that operate using a burst writing technique, where a device on a wide data bus writes to a device on a narrow bus. In burst reading, a device on the slower bus can write data into registers over a number of clock cycles, e.g. four clock cycles, and then a device on the faster bus can read all four bytes in just one clock cycle. FIGS. 5 and 6 are directed to interface circuits that operate using this burst reading technique.

Since writing or reading only one byte of a wide bus is not efficient, the present application provides systems and methods for making more efficient use of the processor's time. Efficient use of the wide bus by the processor involves using all of the available width during each clock cycle. Another efficient use of the wide bus involves reading or writing using the full width of the bus in back-to-back clock cycles, as illustrated in FIG. 7. This reading or writing in back-to-back clock cycles using the full width of the wide bus is referred to as “burst reading” or “burst writing”. The use of burst reading or writing, as explained in more detail below, provides a very efficient method of filling or emptying the byte registers from a processor/DMA perspective.

FIG. 3 is a schematic diagram of an embodiment of an interface circuit 30 for writing data from a wide bus 32 to a narrow bus 34. It should also be apparent that this interface circuit 30 can also be used in an application where a device on the narrow bus 34 reads data from a device on the wide bus 32. In either case, data is transferred from the wide bus 32 to the narrow bus 34.

This embodiment of the interface circuit 30 includes write control logic 36, a number of byte multiplexers 38 and byte registers 40, a register multiplexer 42, a read counter 44, and a status checking module 46. The write control logic 36, byte multiplexers 38, register multiplexer 42, read counter 44, and status checking module 46 may be configured in hardware and/or software. If configured in hardware, these components may comprise any suitable combination of logic elements for accomplishing the functions described herein. If configured in software, these components may comprise any suitable instruction processing modules or programming code having instructions that may be stored on a medium readable by a computer or other type of processing device for carrying out the specific functions described herein.

The write control logic 36 includes two inputs, the first input configured to receive a “data_write” signal indicating that a write procedure is being requested, and the second input configured to receive a “data_size” signal indicating how many bytes are to be written during the writing procedure. In this embodiment, the data_size signal is a two-bit signal having binary values of 00, 01, 10, or 11 representing data sizes of 1 byte, 2 bytes, 3 bytes, and 4 bytes, respectively. In an alternative embodiment in which the size of the wide bus 32 is different than the four-byte bus 32 as illustrated in the present embodiment, the data_size signal will be as many bits as necessary for designating a number of bytes from one byte to a maximum number of bytes that the bus can handle.

As mentioned above, the wide bus 32 and narrow bus 34 may have a width of any number of bytes, depending on the particular design and preferably a number that is a multiple of one byte. In this example, the wide bus 32 has a width of four bytes and the narrow bus 34 has a width of one byte. The interface circuit 30 may be altered according to the number of bytes of each bus. For instance, with the wide bus 32 having a width of four bytes, a circuit designer may preferably design the interface circuit 30 to include a number of byte registers 40 and corresponding byte multiplexers 38 equal to a multiple of four. In this way, four bytes on the wide bus 32 may be written to a set of byte registers 40 on each clock cycle. With eight byte registers 40, burst writing of four bytes in each of two consecutive clock cycles may be performed. With twelve byte registers 40, a burst of three consecutive clock cycles may be performed, and so on. In this regard, the design of the interface circuit 30 may be altered depending on this or other specific speed specifications.

As another example, consider a wide bus 32 having a width of three bytes transferring data to a narrow bus 34 having a width of one byte. If a design specification calls for the writing of twelve bytes per burst, then a designer might alter the design of the interface circuit 30 to include twelve byte registers 40 to meet this specification. This configuration would allow the interface circuit 30 to receive all twelve bytes in four consecutive clock cycles, where three byte registers 40 would be used to receive three bytes from the three-byte bus on a first clock signal, the next set of three byte registers 40 would store the next three bytes from the bus on the next clock, and so on.

Although the interface circuit 30 may contain any number of byte registers 40, another factor that will likely be considered by a circuit designer is the available area on the chip. If less area is available, then of course fewer byte registers could be used. Another factor that may alter the design of the interface circuit 30 is the overall size of the circuit, especially if a greater number of byte registers 40 is used. With a larger size, the length of conductive traces between control logic and the multiplexers 38, 42 would likely be increased to lengths that may result in undesirable delays of control signals travelling between control logic elements and the corresponding multiplexers. In this respect, a designer may choose to keep the overall size relatively small if possible.

Returning again to FIG. 3, the write control logic 36 includes a write counter 48 that acts as a “pointer” to a respective byte register 40. However, instead of pointing to an address of a memory array as in the case of the prior art, the write counter 48 essentially points to the next available byte register 40 in which the next byte is to be written. In response to the data_write and data_size signals, the write counter 48 increments an internal value by an amount equal to the data size. For example, if the data size is three bytes (data_size signal=binary 10), then the counter is incremented three times. If the “Z address” byte register 40Z holds the last written data byte, then the next available byte register 40A will receive the next byte that is written, and byte registers 40B and 40C will receive the next two bytes.

The write counter 48 has a maximum count equal to the number of byte registers 40. Assuming that the interface circuit 30 has eight byte registers 40W, 40X, 40Y, 40Z, 40A, 40B, 40C, and 40D, when the write counter 48 reaches the maximum count designating the last register, e.g. 40D, it will reset to zero on the next count to point to the first register, e.g. 40W. Based on the logic of the write control logic 36, the data_write and data_size signals are processed to control the byte multiplexers 38 in such a way as to allow the data bytes on the wide bus 32 to be loaded in the proper byte registers 40. For example, given eight byte registers 40W, 40X, 40Y, 40Z, 40A, 40B, 40C, 40D and eight corresponding byte multiplexers 38W, 38X, 38Y, 38Z, 38A, 38B, 38C, 38D, and given that the byte registers 40 have been filled up through the fifth register 40A, the write counter 48 will contain a value representing the sixth register 40B into which the next byte will be written. Also, given that the processor requests to write four bytes (data_write is active and data_size is binary 11), the write control logic 36 enables the sixth multiplexer 38B to write the first byte “byte_{—}0” from the wide bus 32 into the sixth byte register 40B, enables the seventh multiplexer 38C to write the second byte “byte_{—}1” into the seventh byte register 40C, enables the eight multiplexer 38D to write the third byte “byte_{—}2” into the eighth byte register 40D, and enables the first multiplexer 38W to write the fourth byte “byte_{—}3” into the first byte register 40W.

When data is loaded into at least one of the byte registers 40, a device (not shown) on the narrow bus 34 may request to begin reading the data from the byte registers 40. The read counter 44 contains the pointer value indicating the byte register 40 that is the next register from which data is to be read. The read counter 44 sends a selection signal indicative of the pointer value to the register multiplexer 42 to select the respective byte register 40. The register multiplexer 42 then passes on the data byte from the selected byte register 40 to the narrow bus 34. This procedure is repeated for each write to the narrow bus 34, one byte at a time.

The write control logic 36 and read control logic 44 each contain a maximum limit value that is equal to the number of byte registers 40. When the maximum value is reached, the control logic resets to zero designating the first register. In addition to this maximum number, the write control logic 36 and read control logic 44 each contain an extra “status bit”, which may be a bit that is toggled when the maximum number is reached or may be placed in the most significant bit position of the pointer count. A “read count value” along with the status bit is sent to the status checking module 46, which also receives the “write count value” along with its status bit. If all the bits in the write count value are the same as all the bits in the read count value, then the status bits can indicate one of two conditions. In a first condition, when the status bits are the same, then the status checking module 46 can determine that the read control logic 44 has read all bytes from the byte registers and is current with the write control logic 36. In this case, the status checking module 46 instructs the read control logic 44 to stop reading. In a second condition, when the status bits are different, then the status checking module 46 can determine that the write control logic 36 has reached the farthest point past the location of the read control logic 44 without overwriting data that has yet to be read by the read control logic 44. In this case, the status checking module 46 informs the write control logic 36 that it cannot write more data until the read control logic is able to read data from the full registers making room for more data.

A processor, or other suitable data transferring device, loads the bytes onto the wide bus 32 such that the first byte is in the byte_{—}0 position, the second byte (if it exists) is in a byte_{—}1 position, the third byte (if it exists) is in a byte_{—}2 position, and the fourth byte (if it exists) is in a byte_{—}3 position. The processor also provides the data_write and data_size signals. The data size indicates which bytes in the byte_{—}0 to byte_{—}3 positions of the wide bus 32 are valid. Usually, the processor will put data out onto the wide bus 32 in a predefined order starting with the first byte at the byte_{—}0 position. If the data is more than one byte wide, then the subsequent bytes will be put out in order as well. For two byte wide data, the data will be put on byte_{—}0 and byte_{—}1. Three bytes will be put out on byte_{—}0, byte_{—}1, and byte_{—}2, etc. In a subsequent write, the processor will again start over with the first byte in position byte_{—}0. However, in an alternative embodiment, if the processor does not put the data out in the predefined order as mentioned above, then the interface circuit 30 will include additional logic to identify the particular order.

FIG. 4 illustrates another embodiment of an interface circuit 50 for transferring data from a wide bus 52 to a narrow bus 54. The transfer of data can be as a result of a burst writing operation from the wide bus 52 to the narrow bus 54 or as a result of a reading operation where the narrow bus 54 reads data from the wide bus 52. Again, data is transferred from the wide bus 52 to the narrow bus 54. In this embodiment, the interface circuit 50 comprises write control logic 56 and data distribution modules 58, each data distribution module 58 including register selection modules 60, data size selection modules 62, AND gate modules 64, and an OR gate module 66. The interface circuit 50 further includes byte registers 68, a register multiplexer 70, and a read counter 72. The interface circuit 50 includes one data distribution module 58 for each respective byte register 68. The data distribution modules 58 may be configured in hardware and/or software for storing valid bytes from the wide bus 52 into the byte registers 68 in a predetermined order.

The register selection modules 60 of each data distribution module 58 are configured to determine the count value from the write control logic 56. For example, if the count value is equal to Z, then the “=Z” module will output an active high signal to the respective AND gate module 64. In the embodiment shown, a first =Z module is applied to the first of the AND gate modules 64Z of data distribution module 58Z and a second =Z module is applied to the second of the AND gate modules 64A of data distribution module 58A. Data distribution modules 58B and 58C, if they were also incorporated in the interface circuit 50, would include =Z modules in the third and fourth positions of the register selection modules 60, respectively, so as to continue the pattern shown.

Next, the data size selection modules 62 provide outputs based on the data size from the data_size signal. If only one byte has been placed on the wide bus 52 and the data size is one, then only the >0 module will provide an active high signal to the first of the AND gate modules 64. If three bytes, for example, are valid on the wide bus 52, then the >0, >1, and >2 modules will be active. In the above example, given that the next available register is byte register 68Z having the “Z address”, and given that the data size is two bytes, then only the >0 module and >1 module will be active. In the first illustrated data distribution module 58Z, the first of the AND gate modules 64Z will provide an output of the first byte “byte_{—}0” from the wide bus 52 to the OR gate module 66Z. This is because the =Z module and >0 module will be the only active signals in this byte selection module 58Z. In the second illustrated data distribution module 58A, the second of the AND gate modules 64A will provide an output of the second byte “byte_{—}1” from the wide bus 52 to the OR gate module 66A since the =Z module and >1 module are the only active signals on the AND gate modules 64A.

The byte registers 68 receive the appropriate bytes from the wide bus 52 via the OR gate modules 66 of the respective data distribution modules 58. The byte registers 68 store the data and output the data to the register multiplexer 70, which selects the next register from which data is read according to the selection signal of the read counter 72. The read counter 72 also includes logic for receiving the data_read signal to indicate when the data can be read out to the narrow bus 54.

FIG. 5 is another embodiment of an interface circuit 74 between a narrow bus 76 and a wide bus 78. In this embodiment data, is transferred from the narrow bus 76 to the wide bus 78 in a burst reading procedure. The interface circuit 74 includes a write counter 80, a register demultiplexer 82, byte registers 84, bus demultiplexers 86, and read control logic 88. The write counter 80 receives a data_write signal from a device operating on the narrow bus 76 and provides a count signal to the register demultiplexer 82 for writing the byte of data from the narrow bus 76 into the next available byte register 84. When the processor, or other type of data transmission device on the wide bus 78, sends a data_read signal to the read control logic 88 along with a data_size signal, the read control logic 88 selects up to four bytes, assuming that the wide bus 78 is four bytes wide, from the appropriate byte registers 84. The read control logic 88 provides selection signals according to a read count value incremented with respect to the data_read and data_size signals, as mentioned above, to the appropriate bus demultiplexers 86. These selection signals are sent to the bus demultiplexers 86 all at once such that the selected bytes are fed by the bus demultiplexers 86 into the proper byte positions of the wide bus 78 with a first byte is placed at the byte_{—}0 position, a second byte is placed at byte_{—}1, etc. The processor is then able to read the bytes, up to four at a time, from the wide bus 78 in one clock cycle. If enough byte registers 84 are provided in the interface circuit 74, i.e. at least eight byte registers 84 for a four-byte bus 78, then the processor can read a second set of four bytes from the byte registers 84 in the subsequent clock cycle by selecting the appropriate bus demultiplexers 86.

FIG. 6 is a schematic diagram of another embodiment of an interface circuit 90 for interfacing between a narrow bus 92 and a wide bus 94. In this embodiment, data is transferred from the narrow bus 92 to the wide bus 94 in a process where a device on the narrow bus 92 writes to a device on the wide bus 94 or a process where a device on the wide bus 94 reads from a device on the narrow bus 92. The interface circuit 90 includes a write counter 96, a demultiplexer 98, byte registers 100, data distribution modules 102, and read control logic 104. The write counter 96, data distribution modules 102, and read control logic 104 can be configured in hardware and/or software. The data distribution modules 102 include bus location selection modules 106, data size selection modules 108, and AND gate modules 110.

The write counter 96 receives a data_write signal indicating a request to write data from the narrow bus 92. The write counter 96 increments as mentioned with respect to the similar elements described above and selects the next available byte register 100 to which the data is to be written. The read control logic 104 receives a data_read signal and a data_size signal from a device on the wide bus 94. In response, the read control logic 104 outputs a value, such as a pointer value, representing which byte register 100 is the next available register from which data is to be read. This value is detected by the bus location selection modules 106 for determining which bytes from the appropriate byte registers 100 are to be placed on the appropriate portions of the wide bus 94. For instance, if the read control logic 104 outputs the value Z, indicating that the byte register having the Z-address is the next available register, then the =Z module in each data distribution module 102 provides a logic high output to the respective AND gate module 100. Also, with the data size at least one, at least the >0 module of the data size selection modules 108 will also provide a logic high output to the AND gate modules 110. In this case, the Z-address byte register 100Z provides the stored data byte via the first of the AND gate modules 110Z to the byte_{—}0 portion of the wide bus 94. In this same example, if the data size is at least two, then the =Z module and >1 modules will provide high signal to the second of the AND gate modules 110A of data distribution module 102A to apply the data byte of the A-address byte register 100A onto the second byte location “byte_{—}1” of the wide bus 94.

It should be noted that the embodiments of FIGS. 4-6 may also include the status checking module 46 shown in FIG. 3. In these embodiments, the status checking module 46 would operate in a similar manner as explained with respect to the description of FIG. 3. Particularly, the status checking module 46 receives the read count value from the read counter or read control logic and the write count value from the write counter or write control logic, and determines whether all the bytes registers are full, some of the registers are full, or none of the registers are full. When all are full, the writing device is instructed to stop writing and the read device is enabled to continue reading. When none are full, the reading device is instructed to stop reading and the writing device is enabled to continue writing. When some are full, both reading and writing may continue. The status checking module 46 may also send an error signal to indicate if either the reading device is reading from empty registers or the writing device is writing to full registers.

FIG. 7 is a timing diagram illustrating an example of signal activity according to the embodiments of FIGS. 3-6. Whether reading or writing, it can be seen that the processor is allowed to write or read a number of bytes, even in consecutive clock cycles, from a corresponding number of registers in the interface circuits. In the embodiments of FIGS. 3 and 4 showing interface circuits for writing from a wide bus to a narrow bus, the processor can write up to eight bytes in two clock cycles into the at least eight registers of the interface circuit. In the embodiments of FIGS. 5 and 6 showing interface circuits for writing from a narrow bus to a wide bus, the at least eight registers on the slow side can store up eight bytes and write the bytes four at a time to the processor in two clock cycles. In either case, the processor is active for the data transaction for only two clock cycles, whereas in the prior art it would have taken the processor eight clock cycles to access the data. With the processor operating at the high speed of the wider bus, the processor can then direct attention to other processing steps and the processor is able to function more efficiently and more quickly.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

I claim:

1. An interface circuit for transferring data between buses of different widths, the interface circuit comprising:
a plurality of byte registers;
first control logic configured to provide a first selection signal to a plurality of first distribution devices, each of the first distribution devices controlling communication between one of the byte registers and one of a plurality of byte locations on a first bus; and
second control logic configured to provide a second selection signal to a second distribution device, the second distribution device controlling communication between one of the plurality of byte registers and a second bus, the second bus having a width of a fewer number of bytes than the width of the first bus.

2. The interface circuit of claim 1, wherein the first control logic receives a first signal and a second signal from a device operating on the first bus, the first signal indicating a request to access data in the byte registers, the second signal indicating the number of bytes of data to be accessed.

3. The interface circuit of claim 2, wherein the first control logic comprises a counter having a count signal that increments by the number indicated by the second signal.

4. The interface circuit of claim 3, wherein the count signal indicates which byte register communicates with which byte location on the first bus.

5. The interface circuit of claim 1, wherein the second control logic receives a signal from a device on the second bus, the signal indicating a request to access data in the byte registers.

6. The interface circuit of claim 5, wherein the second control logic is a counter having a count signal.

7. The interface circuit of claim 6, wherein the count signal indicates which byte register communicates with the second bus.

8. The interface circuit of claim 1, further comprising:
a status checking module configured to receive a first count value from the first control logic and a second count value from the second control logic, wherein, in response to the first and second count values, the status checking module provides a stop signal or a continue signal to each of the first control logic and second control logic.

9. The interface circuit of claim 8, wherein one of the first control logic and second control logic comprises write control logic and the other of the first control logic and second control logic comprises read control logic.

10. The interface circuit of claim 9, wherein the status checking module provides the stop signal to the read control logic when the read control logic has read all bytes written into the byte registers by the write control logic.

11. The interface circuit of claim 9, wherein the status checking module provides the continue signal to the read control logic when the read control logic has not read all bytes written into the byte registers by the write control logic.

12. The interface circuit of claim 9, wherein the status checking module provides the stop signal to the write control logic when the write control logic has written into a number of byte registers beyond the byte registers read by the read control logic without overwriting data.

13. The interface circuit of claim 9, wherein the status checking module provides the continue signal to the write control logic when the write control logic has not written into a number of byte registers beyond the byte registers read by the read control logic without overwriting data.

14. The interface circuit of claim 1, wherein each of the first distribution devices is a multiplexer for writing data from one of the byte locations on the first bus to the respective byte register, the one byte location being selected based on the first selection signal.

15. The interface circuit of claim 14, wherein the second distribution device is a multiplexer for writing data from one of the byte registers to the second bus, the one byte register being selected based on the second selection signal.

16. The interface circuit of claim 1, wherein the second distribution device is a demultiplexer for writing data from the second bus to one of the byte registers, the one byte register selected based on the second selection signal.

17. The interface circuit of claim 16, wherein each of the first distribution devices is a demultiplexer for writing data from the respective byte register to one of the byte locations on the first bus, the one byte location selected based on the first selection signal.

18. The interface circuit of claim 1, wherein each of the first distribution devices comprises a plurality of register selection modules, a plurality of data size selection modules, a plurality of AND gate modules, and an OR gate module, each of the AND gate modules configured to transfer data from a respective byte location on the first bus to the OR gate module when a respective register selection module and respective data size selection module provide active signals to the AND gate module, the OR gate module configured to transfer the data to a respective byte register.

19. The interface circuit of claim 1, wherein each of the first distribution devices comprises a plurality of bus location selection modules, a plurality of data size selection modules, and a plurality of AND gate modules, each of the AND gate modules configured to transfer data from a respective byte register to one of the byte locations on the first bus when a respective bus location selection module and respective data size selection module provide active signals to the AND gate module.

20. A system for interfacing a first bus with a second bus, the system comprising:
a plurality of temporary storage components;
first means for transferring data between a first bus and at least one of the temporary storage components in a single clock cycle;
second means for transferring data between a second bus and the at least one of the temporary storage components in a number of clock cycles.

21. The system of claim 20, wherein data is transferred between a first device connected to the first bus and a second device connected to the second bus.

22. The system of claim 21, wherein the first data transferring means comprises:
means for distributing data between at least one of a plurality of locations on the first bus and at least one of the temporary storage components;
means for controlling the data distributing means based on a data access signal and a data size signal.

23. The system of claim 22, wherein the first device provides the data size signal indicating the number of bytes of data to be transferred in the single clock cycle.

24. The system of claim 22, wherein the data access signal is one of a data write signal requesting to write data to the temporary storage components and a data read signal requesting to read data from the temporary storage components.

25. The system of claim 21, wherein the second data transferring means comprises:
means for distributing data between the second bus and at least one of the temporary storage components;
means for controlling the data distributing means based on a data access signal.

26. The system of claim 25, wherein the data access signal is one of a data write signal requesting to write data to the temporary storage components and a data read signal requesting to read data from the temporary storage components.

27. The system of claim 20, wherein the first bus has a width of two or more bytes, the second bus has a width that is narrower that the first bus, the first data transferring means transfers data in one clock cycle from the first bus to a number of the temporary storage components, and the second data transferring means transfers data from the number of the temporary storage components to the second bus.

28. The system of claim 27, wherein the first data transferring means transfers only valid bytes.

29. The system of claim 20, wherein the first bus has a width of two or more bytes, the second bus has a width that is narrower than the first bus, the second data transferring means transfers data from the second bus to a number of the temporary storage components, and the first data transferring means transfers data in one clock cycle from the number of the temporary storage components to the first bus.

30. A method for interfacing a first bus with a second bus, the method comprising:
transferring a plurality of bytes of data between a first bus and a corresponding number of registers in one clock cycle; and
transferring the plurality of bytes of data between a second bus and the registers one byte per clock cycle;
wherein the first bus has a greater width than the second bus.

31. The method of claim 30, wherein transferring data between the first bus and the registers further comprises:
receiving a data_write signal and a data_size signal;
processing the data_write and data_size signals to provide selection signals; and
multiplexing data bytes, based on one of the selection signals, from a plurality of locations on the first bus to each of the registers.

32. The method of claim 31, wherein receiving the data_write signal and data_size signal comprises receiving the signals from a first device in communication with the first bus.

33. The method of claim 32, wherein the data_write signal indicates a request by the first device to write data to a number of the registers.

34. The method of claim 31, wherein the data_size signal indicates which bytes on the first bus are valid.

35. The method of claim 30, wherein transferring data between the first bus and the registers further comprises:
receiving a data_read signal and a data_size signal;
processing the data_read and data_size signals to provide selection signals; and
demultiplexing data from each of the registers to one of a plurality of locations on the first bus based on one of the selection signals.

36. The method of claim 35, wherein receiving the data_read signal and data_size signal comprises receiving the signals from a first device in communication with the first bus.

37. The method of claim 36, wherein the data_read signal indicates a request by the first device to read data from a number of the registers.

38. The method of claim 35, wherein the data_size signal indicates which bytes in the registers are valid.

39. The method of claim 30, wherein transferring data between the second bus and the registers further comprises:
receiving a data_read signal;
processing the data_read signal to provide a selection signal; and
multiplexing data bytes, based on the selection signal, from the registers to the second bus.

40. The method of claim 39, wherein receiving the data_read signal comprises receiving the data_read signal from a second device in communication with the second bus.

41. The method of claim 40, wherein the data_read signal indicates a request by the second device to read data from a number of the registers.

42. The method of claim 30, wherein transferring data between the second bus and the registers further comprises:
receiving a data_write signal;
processing the data_write signal to provide a selection signal; and
demultiplexing data from the second bus to one of the registers based on the selection signal.

43. The method of claim 42, wherein receiving the data_write signal comprises receiving the data_write signal from a second device in communication with the second bus.

44. The method of claim 43, wherein the data_write signal indicates a request by the second device to write data to one of the registers.
